(19) United States
(12) Patent Application Publication
(10) Pub. No.: US 2003/0016631 A1
(43) Pub. Date: Jan. 23, 2003

(54) Hotel computer networking system

(76) Inventors: William C. Piner, Myrtle Beach, SC (US); Thomas Ghinis, Murrells Inlet, SC (US)

Correspondence Address: Craig N. Killen, Nelson Mullins Riley & Scarborough, P.O. Box 11070, Columbia, SC, 29211, US

(21) Appl. No.: 10/178,948

(22) Filed: Jun. 24, 2002

Related U.S. Application Data
(60) Provisional application No. 60/300,278, filed on Jun. 22, 2001.

(51) Int. Cl. H04L 12/28; H04J 15/00; H04J 3/10; H04J 1/12

(52) U.S. Cl. 370/254; 370/201

(57) ABSTRACT

A computer network is installed in a building such as a hotel having a plurality of rooms. The building has a preexisting electrical wiring grid to distribute electrical power to the rooms. At least one power line injector is operatively connected between a server computer and the electrical wiring grid to transfer data therebetween. The data is thus transmitted and received across the electrical wiring grid via a modulated carrier. A plurality of power line modems are respectively installed in the rooms of the building and are connected to the electrical wiring grid to selectively transmit and receive the data. In addition, a plurality of end user computers are respectively associated with the power line modems.

### PRIORITY CLAIM

This application claims the benefit of copending provisional application serial No. 60/300,278, filed Jun. 22, 2001, which is relied on herein and incorporated herein by reference.

### BACKGROUND OF THE INVENTION

The present invention relates generally to systems for providing internet access hotel patrons and the like.

Ease of access to the internet is becoming an increasingly important factor considered by business travelers in determining their choice of hotel. Hotels are seeking to meet this market demand by providing each guestroom with suitable infrastructure to access the internet. For example, virtually all hotel guestrooms in the United States are now equipped with telephones having a dataport to which a standard telephone modem can be connected. This provides the patron with the capability of accessing the internet via a dial-up connection.

Many users, however, find a dial-up connection to be unsatisfactory for their purposes. For example, a dial-up connection does not have sufficient bandwidth to permit video streaming and other functions requiring a high rate of data transfer. This can be particularly frustrating for users who are accustomed to high speed internet access at their place of work. As a result, some hotels are now equipping each guestroom with an Ethernet connection for use by patrons with suitably equipped computers.

While it is relatively easy to provide an Ethernet connection in each guestroom at the time a hotel is constructed, this is much more difficult to accomplish in an existing building. As one skilled in the art will appreciate, specific electrical wiring will generally have to be “pulled” into each room. Moreover, the wiring will have to be installed in a manner that does not disrupt the room's existing décor. At least some of the rooms will also need to be vacant while this work is being conducted, which can adversely affect the hotel's cash flow.

In addition, the creation of an effective network based on the computers of hotel patrons is a challenging task. This is because hotel guests represent an ever-changing group of users whose computers have a variety of preset network settings.

### SUMMARY OF THE INVENTION

The present invention recognizes and addresses the foregoing considerations, and others, of prior art constructions and methods.

According to one aspect, the present invention provides a computer network installed in a building such as a hotel having a plurality of rooms. The building has a preexisting electrical wiring grid to distribute electrical power to the rooms. At least one power line injector is operatively connected between a server computer and the electrical wiring grid to transfer data therebetween. The data is thus transmitted and received across the electrical wiring grid via a modulated carrier. A plurality of power line modems are respectively installed in the rooms of the building and are connected to the electrical wiring grid to selectively transmit and receive the data. In addition, a plurality of end user computers are respectively associated with the power line modems.

In some exemplary embodiments, the server computer is operative to communicate with a common gateway node providing access to the internet. Often, the end user computers have disparate network settings which are advantageously spoofed by the server computer. In addition, embodiments are contemplated in which the server computer communicates with billing software so that access to the internet can be monitored for billing purposes. In addition, the server computer and the end user computers will preferably communicate with each other via Ethernet protocol.

Preferably, the power line modems may be connected into the electrical wiring grid by being plugged into electrical outlets in the rooms. Moreover, the end user computers may be connected to respective power line modems via wire cable. In some cases, the computer network comprises a plurality of power line injectors each communicative with a predetermined subset of power line modems. The multiple power line injectors may preferably modulate and demodulate data at different carrier frequencies to reduce crosstalk. Furthermore, embodiments are contemplated in which the power line injector(s) are either directly coupled or are inductively coupled to the electrical wiring grid.

In another aspect, the present invention provides a computer network for providing a plurality of end user computers having disparate network settings access to the internet via a common gateway node. The network comprises an internet gateway device providing the common gateway node. A plurality of modems each having a unique identifier are also provided. The modems are adapted for connection to respective end user computers. In addition, a server computer is operatively situated between the end user computers and the internet gateway device. The server computer functions to spoof the end user computers to allow the end user computers to communicate with the gateway node notwithstanding a preset network setting of each end user computer.

A still further aspect of the present invention provides a computer network in a building such as a hotel having a plurality of rooms. The building has a preexisting electrical wiring grid to distribute electrical power to the rooms. At least one power line injector is operatively connected between a server computer and the electrical wiring grid to transfer data therebetween. The data is transmitted and received across the electrical wiring grid via a modulated carrier.

The computer network further includes a plurality of power line modems respectively installed in the rooms of the building. The power line modems are connected to the electrical wiring grid to selectively transmit and receive data. A plurality of end user computers are respectively associated with the power line modems. Advantageously, the server computer spoofs the end user computers to allow network communication therewith via Ethernet protocol notwithstanding a preset network setting of each end user computer.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof to one of ordinary skill in the art, is set forth more particularly in the remainder of the specification, which makes reference to the accompanying drawings, in which:

FIG. 1 is a block diagram of a computer network constructed in accordance with the present invention;

FIG. 2 is a diagrammatic representation of a hotel equipped with a computer network in accordance with the present invention;

FIG. 3 illustrates a power line modem and end user computer which may be provided in each guestroom of the hotel;

FIG. 4 illustrates a direct method of injecting modulated carrier signals onto the electrical wiring grid of the hotel;

FIG. 5 illustrates an indirect method of injecting modulated carrier signals onto the electrical wiring grid of the hotel; and

FIG. 5A is an enlarged view of one of the couplers shown in FIG. 5.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention.

As will now be described, embodiments of the present invention utilize power line data distribution technology to distribute and receive data packets over the existing electrical wiring grid of a Multiple Dwelling Unit/Multiple Tenant Unit (MDU/MTU) building or other such facility having a plurality of rooms. Each of the rooms is preferably equipped with a power line modem which is simply plugged into a standard electrical outlet. In such embodiments, a person within the room can send and receive data packets by connecting a computer to the power line modem. The system includes a server, known as a “smart box,” which monitors and controls the flow of communication between the various end user computers and a common gateway node providing access to the internet.

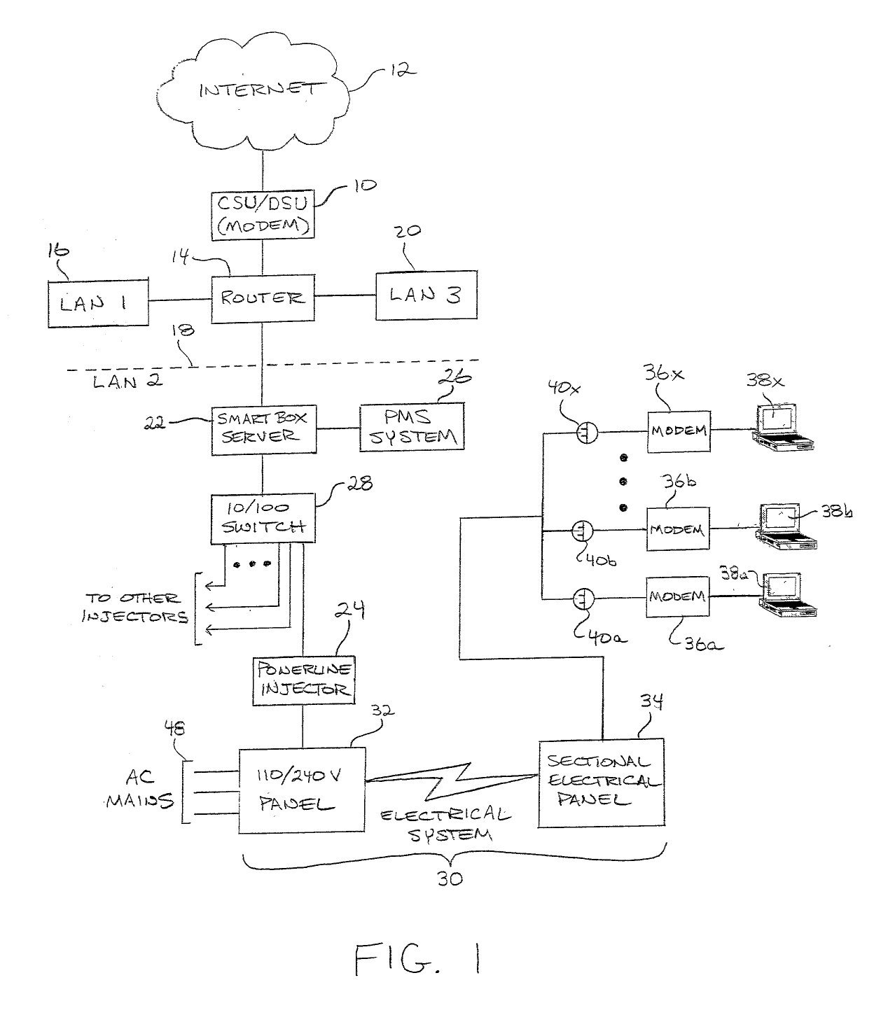

One embodiment of a computer network constructed in accordance with the present invention is illustrated in FIG. 1. As can be seen, a suitable gateway device 10, such as a CSU/DSU (modem), transfers data packets to and from the internet (indicated generally at 12). Various connections are contemplated between device 10 and the internet backbone, such as cable, xDsl, Tx, wireless, wireless mesh grid, satellite, or the like.

In many cases, a router 14 (which may often be incorporated into device 10) will also be provided. As known to those skilled in the art, a router functions to connect multiple local area networks (LANs), such as LANs 1-3 (also indicated by reference numbers 16, 18 and 20). In this example, LAN 2 (reference number 18) is shown in greater detail so that certain principles of the present invention can be explained. LANs 1 and 3 may be constructed in accordance with the present invention, or may be conventional LANs.

As shown, LAN 2 (reference number 18) includes a smart box server 22 in operative communication with device 10. Server 22 functions to monitor and control each end user node as they are brought into and out of the network. In this regard, server 22 sends/receives data packets to and from at least one power line injector 24 for communication with the appropriate end user. Often, server 22 will also communicate with the hotel's property management system (PMS) 26 so that each end user's internet access can be tracked (such as for billing purposes). A suitable splitter, such as 10/100 switch 28, may be provided to allow connection to multiple power line circuits (as will be explained more fully below).

Power line injector 24 transmits and receives data across the building's preexisting electrical wiring grid 30. As a result, the network can be created and maintained without the need to run specialized wiring into each of the hotel's guestrooms. In many cases, it will be preferable to inject the signals onto the grid at the building's main 110/240 V panel 32. This is because all electrical outlets in the entire building must be connected to this panel if they are to have electricity. This will virtually ensure that the data will reach every point that is pulling power from the electrical box.

In a typical installation, the electrical circuits to multiple guestrooms will originate at a sectional electrical panel 34. A respective power line modem (36a, 36b, . . . 36x) is installed in each guestroom for connection to a respective end user computer (38a, 38b, . . . 38x). To provide network communication with the electrical power grid, each of the power line modems is connected (as indicated at 40a, 40b, . . . 40x) to a standard electrical outlet located in the room.

Power line injector 24 and modems 36 translate data packets from a format compliant with regular network protocol (such as Ethernet) into a form that can be transmitted on the electrical wiring grid. Generally, this will involve modulation and demodulation of a carrier having a predetermined frequency. As one skilled in the art will recognize, various carrier frequencies and modulation bandwidths may be used for this purpose. The particular modulation technique may also vary, depending on the exigencies of a particular application. Details regarding the construction of power line modems are described in U.S. Pat. No. 6,396,392 to Abraham, incorporated herein by reference.

Referring now to FIG. 2, a hotel 42 is illustrated having multiple users (designated “Users 1-5”) in respective guestrooms of each floor of the building (designated “Floors 1-4”). Each floor includes an associated power line injector 24a-d to transfer data packets to and from the electrical power circuits of the particular floor. To reduce crosstalk interference between users on the respective floors, each of the injectors 24a-d may use a different carrier frequency (respectively designated f₁-f₄)

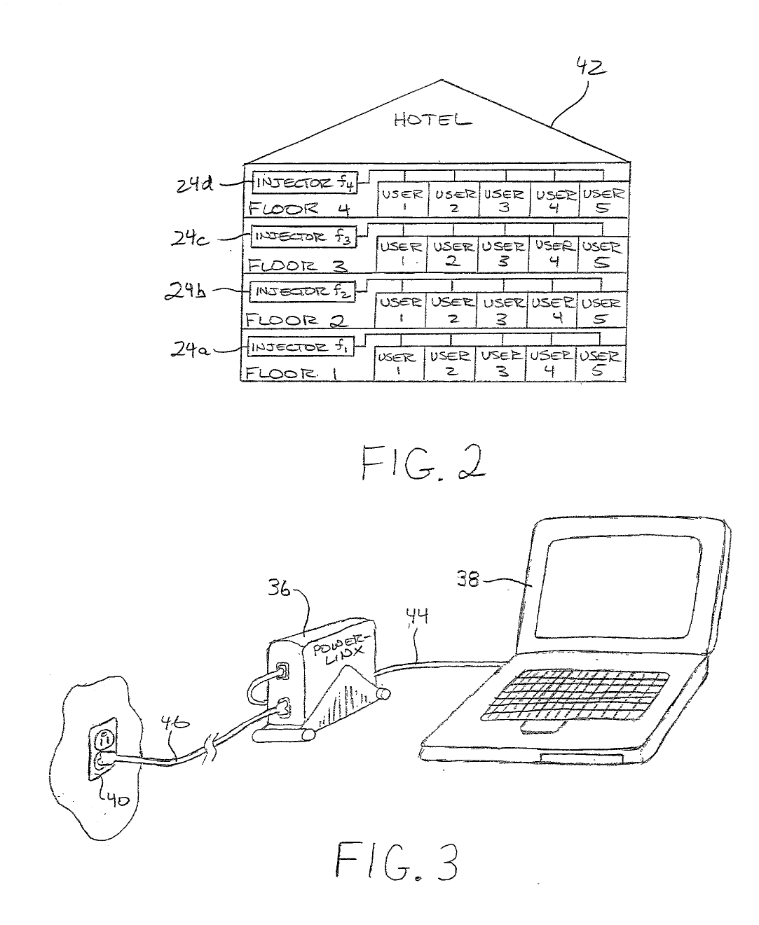

FIG. 3 illustrates an end user computer 38 connected to a power line modem 36 in one of the hotel guestrooms. In this case, computer 38 is connected via a cable wire 44, although wireless connections are also contemplated. Typically, cable wire 44 may be an Ethernet cord that connects via RJ45 or USB ports at both ends. Power wire 46 connects power line modem 36 to the standard electrical outlet for network communication, and also provides power to operate the modem itself.

While computer 38 will often be a laptop computer as shown, embodiments are contemplated in which various other types of computing devices are also utilized. For example, computer 38 may be a “palm top” computer, a personal digital assistant (PDA), a web-enabled cellular telephone or other such device.

Referring again to FIG. 1, the network settings on each of the end user computers will vary widely from computer to computer in many applications of the present invention. This would normally present a substantial problem, because a particular end user computer is not typically permitted to communicate with a network for which it has not been set. To overcome this problem, server 22 preferably utilizes a “spoofing” technique to permit each end user computer 38 to communicate to the network and to the internet regardless of its network settings. For example, a layer 2 spoofing technique may be utilized in a solid state and/or hard drive enabled device to allow participation by any computer with an Ethernet port regardless of its TCP/IP or e-mail (e.g., SMTP/POP 3) settings. In this manner, various end user computers may function as true “plug and play” units in a network of the present invention. Various details regarding nomadic translator technology can be found in U.S. Pat. No. 6,130,892 to Short, incorporated herein by reference.

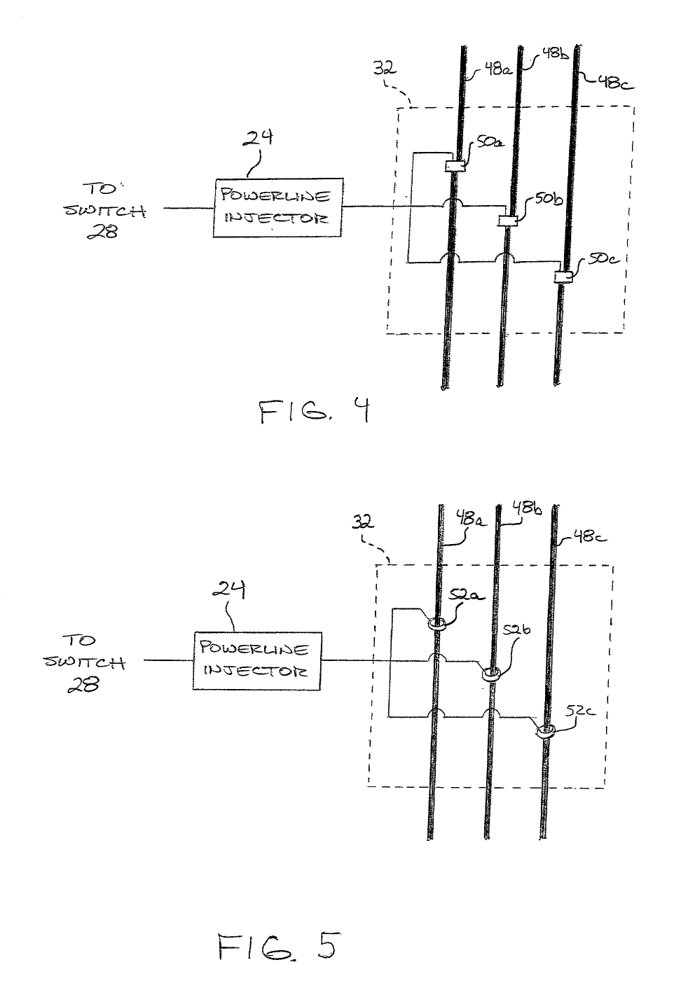

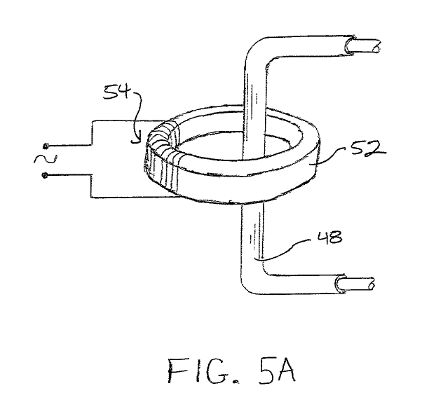

FIGS. 4 and 5 illustrate alternative techniques for transfer of data packets between power line injector 24 and the main power lines of the electrical grid. In FIG. 4, power line injector 24 is directly coupled to the individual three-phase power lines 48a-c at respective couplers 50a-c. In this case, couplers 50a-c may be various capacitive coupling devices known in the art.

While direct coupling often produces superior performance, it may be considered undesirable in many applications because of the required physical connection with the main power lines. Thus, FIG. 5 illustrates an alternative technique in which power line injector 24 is coupled via electromagnetic couplers 52a-c. Couplers 52a-c utilize magnetic induction to inject/receive data packets to/from power line modems 36. Specifically, as shown in FIG. 5A, each of the structure's main feed lines 48 essentially becomes the secondary coil of a transformer circuit having primary coil 54.

To compensate for the lack of a direct wired injection/receiving method when utilizing magnetic induction coupling, the power output and receiving sensitivity of injector 24 may be increased to the point where the overall signal level running through the structure's electrical wiring grid will be in compliance with FCC Rule 15 but will allow for a signal level similar to that of direct coupling.

It is contemplated that various features may be incorporated into nodes of a computer network constructed in accordance with the present invention. For example, the various nodes may contain some or all of the following features:

1. Data throughput of 0 to 1 Gigabytes per second.

2. Voice over IP enabled either built into circuit board or with an additional plug-in circuit board card.

3. Either 900 MHz/2.4 GHz/5.0 GHz wireless network enabled utilizing either 802.11 a, b or g and/or the Bluetooth standard. These configurations may be accomplished with an optional upgradable plug-in PCMCIA card or built onto the circuit board.

4. Video streaming at up to 50 Megabytes per second to allow for video-on-demand, video conferencing or other video streaming applications.

5. SNMP and MIB/Romon enabled.

6. Wake on LAN; Wake on Notify on Ethernet port and power supply enabled.

7. 128 3DES Automatic Key Set enabled or other suitable encryption technique.

8. Automatic Key Refresh.

9. Peer to peer privacy.

10. 110/240 dual voltage power supply.

11. Pass through plug built in.

12. Network segmentation through frequency segmentation enabled.

13. Sleep Mode to save power.

14. Built in data buffering in the power line modems to increase network communication speeds.

15. Power switch built in to the power line modems.

16. Downward compatible.

17. Flashable ROM to permit remote upgrades to power line modem as desirable in the future.

18. The power line modems may be equipped with various LED status lights.

It can thus be seen that the present invention provides a computer network achieving various advantages in comparison with the prior art. While preferred embodiments of the invention have been shown and described, modifications and variations may be made thereto by those of ordinary skill in the art without departing from the spirit and scope of the present invention. It should also be understood that aspects of the various embodiments may be interchanged both in whole or in part. Those of ordinary skill in the art will also appreciate that the foregoing description is by way of example only, and is not intended to be limitative of the invention as further described in the appended claims.

What is claimed is:

1. In a building such as a hotel having a plurality of rooms, a computer network comprising:
a preexisting electrical wiring grid installed in said building to distribute electrical power to said rooms;
a server computer;
at least one power line injector operatively connected between said server computer and said electrical wiring grid to transfer data therebetween, said data being transmitted and received across said electrical wiring grid via a modulated carrier;
a plurality of power line modems respectively installed in said rooms of said building, said power line modems being connected to said electrical wiring grid to selectively transmit and receive said data; and
a plurality of end user computers, said computers being associated with respective of said power line modems.

2. A computer network as set forth in claim 1, wherein said server computer communicates with a common gateway node providing access to the internet.

3. A computer network as set forth in claim 2, wherein said plurality of end user computers have disparate network settings which are spoofed by said server computer.

4. A computer network as set forth in claim 3, wherein said server computer communicates with billing software so that access to the internet can be monitored for billing purposes.

5. A computer network as set forth in claim 3, wherein said server computer and said end user computers communicate with each other via Ethernet protocol.

6. A computer network as set forth in claim 1, wherein said power line modems are connected into said electrical wiring grid by being plugged into electrical outlets in said rooms.

7. A computer network as set forth in claim 6, wherein said end user computers are connected to respective of said power line modems via wire cable.

8. A computer network as set forth in claim 1, wherein said at least one power line injector comprises a plurality of power line injectors each communicative with a predetermined subset of said power line modems.

9. A computer network as set forth in claim 8, wherein said power line injectors modulate and demodulate said data at a different respective carrier frequency to reduce crosstalk.

10. A computer network as set forth in claim 1, wherein said at least one power line injector is directly coupled to said electrical wiring grid.

11. A computer network as set forth in claim 1, wherein said at least one power line injector is inductively coupled to said electrical wiring grid.

12. A computer network for providing a plurality of end user computers having disparate network settings access to the internet via a common gateway node, said network comprising:
an internet gateway device providing said common gateway node;
a plurality of modems each having a unique identifier, said modems being adapted for connection to respective of said end user computers;
a server computer operatively situated between said end user computers and said internet gateway device; and
said server computer spoofing said end user computers to allow said end user computers to communicate with said gateway node notwithstanding a preset network setting of each said end user computer.

13. A computer network as set forth in claim 12, wherein said server computer and said end user computers communicate via Ethernet protocol.

14. A computer network as set forth in claim 12, wherein said modems are power line modems which communicate with said server computer via a preexisting electrical wiring grid.

15. A computer network as set forth in claim 14, wherein said power line modems are connected into said electrical wiring grid by being plugged into electrical outlets.

16. A computer network as set forth in claim 14, wherein said server computer is operatively connected to a plurality of power line injectors each communicative with a predetermined subset of said power line modems.

17. A computer network as set forth in claim 16, wherein said power line injectors utilize different carrier frequencies to reduce crosstalk between said subsets of said power line modems.

18. In a building such as a hotel having a plurality of rooms, a computer network comprising:
a preexisting electrical wiring grid installed in said building to distribute electrical power to said rooms;
a server computer;
at least one power line injector operatively connected between said server computer and said electrical wiring grid to transfer data therebetween, said data being transmitted and received across said electrical wiring grid via a modulated carrier;
a plurality of power line modems respectively installed in said rooms of said building, said power line modems being connected to said electrical wiring grid to selectively transmit and receive said data;
a plurality of end user computers, said computers being associated with respective of said power line modems; and
said server computer spoofing said end user computers to allow network communication therewith via Ethernet protocol notwithstanding a preset network setting of each said end user computer.
